(19) United States
(12) Patent Application Publication
(10) Pub. No.: US 2014/0168748 A1
(43) Pub. Date: Jun. 19, 2014

(54) Multilayer Colour Change Material

(71) Applicant: Ingo Schmidt-Wolf, Bonn (DE)

(72) Inventor: Ingo Schmidt-Wolf, Bonn (DE)

(21) Appl. No.: 14/113,492

(22) PCT Filed: Apr. 27, 2011
(86) PCT No.: PCT/EP2011/056676

§ 371 Date: Jan. 24, 2014

(51) Int. Cl. G02F 1/23

(52) U.S. Cl. CPC G02F 1/23
USPC 359/290

(57) ABSTRACT

Multilayer colour change material, comprising a transparent or translucent top layer, five colour layers, each colour layer comprising 2 flexible foils, whereby the first to the fourth colour layer are each connected with a fluid reservoir device which allows the reversible influx of a colour fluid or a black fluid from a fluid reservoir into a space between two flexible foils of a colour layer, and whereby the fifth colour layer is connected with a transparent fluid reservoir device which allows the reversible influx of a transparent fluid from the transparent fluid reservoir device into a space between the two flexible foils, and a back layer.

### CROSS-REFERENCE TO RELATED APPLICATIONS

This application is a national stage application under 35 U.S.C. 371 of International Patent Application Ser. No. PCT/EP2011/056676, entitled “MULTILAYER COLOUR CHANGE MATERIAL”, filed Apr. 27, 2011, the disclosure of which is incorporated herein by reference.

### FIELD OF THE INVENTION

The present invention is directed to a multilayer colour change material and its use as a colour change surface for buildings, furniture, textiles or vehicles. The invention is also directed to the use of such materials as tingeing sheets for a window which allow the colouring of the light transmitting the window.

### BACKGROUND

The human retina creates an image of the visual world by means of photo receptors in forms of rods and cones. While the rods are highly sensitive towards light within a wider range of wave length and therefore are not colour sensitive, the cones are strongly colour selective. Cone cells fall into three different categories, being most responsive to the colours yellow, green and blue, respectively. By these three different types of cone cells, the human visual system is able to construct a visual image of colours.

Conventional display technology uses the principle of additive colour. The additive colour production process conventionally uses red, green and blue light emitting entities to produce the colour. Such conventional display systems have the disadvantage that they usually require an intense backlighting to avoid a grey appearance of their surface.

The subtractive colour system is often used in printing processes. The subtractive colour system used in a printing process starts from a white surface (e.g. the surface of paper) and adds coloured inks which cause subtraction (e.g. absorption) of a certain wave length while reflecting the others. By using coloured inks for the colours cyan, magenta and yellow, and in most cases an additional black ink, the colour can be constructed by the subtractive colour system. While the subtractive colour system allows the construction of almost any colour on a surface without the need of back-lighting, the printing process used for this is irreversible and does not allow a change of the colour of the surface.

Technologies which allow the change of the appearance and/or colour of a surface include electrochromic materials and thermochromic materials. However, these technologies allow the change of the appearance and/or colour of a surface only to a very limited extend. None of these technologies allows to freely choosing the colour of a surface. Moreover, these technologies require the use of substantial amounts of energy in order to effect the change of the appearance and/or colour of the surfaces.

### BRIEF DESCRIPTION OF THE DRAWINGS

FIGS. 1a-d gives a schematic representation of a multilayer colour change material according to the present invention from different perspectives.

FIGS. 2a-d gives a further schematic view from different perspectives with included ranges for the thickness of the layer and of the flexible foils of the first to fifth colour layers.

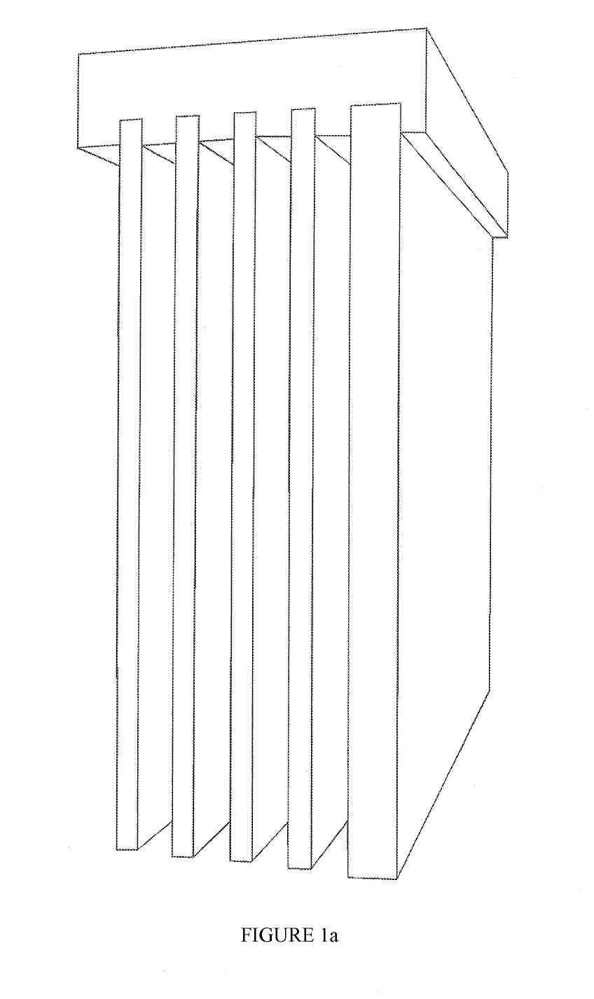

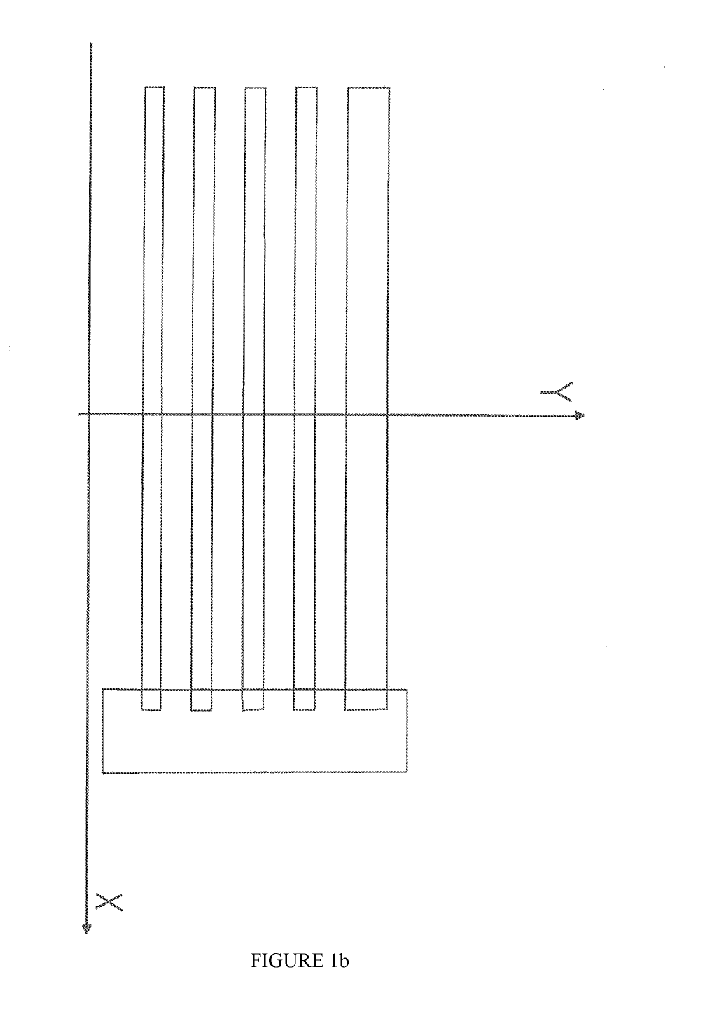

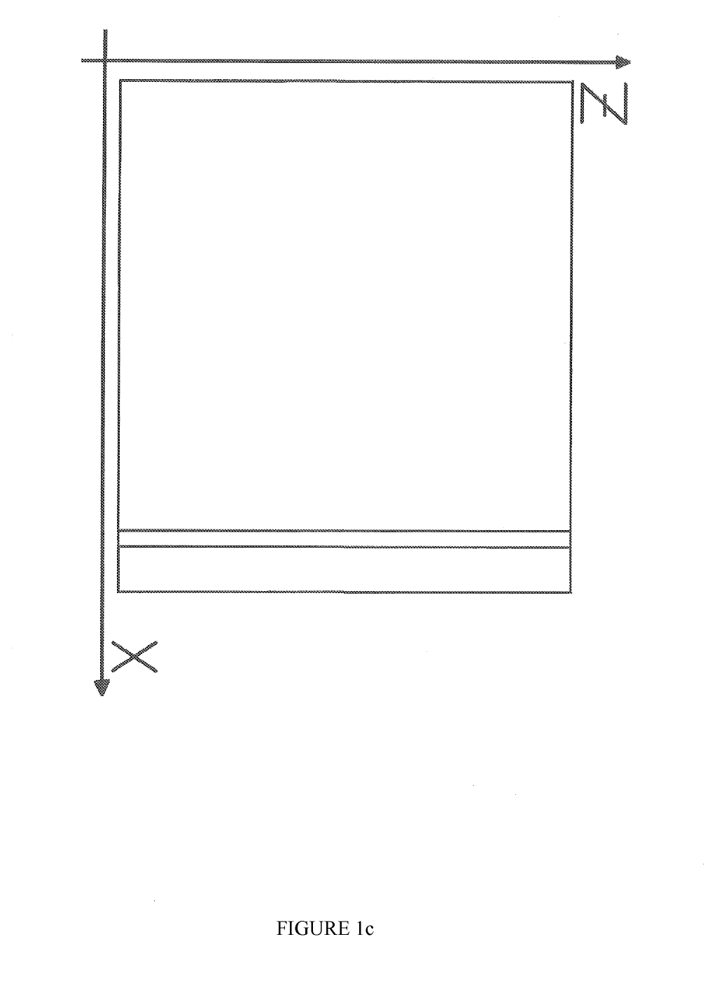

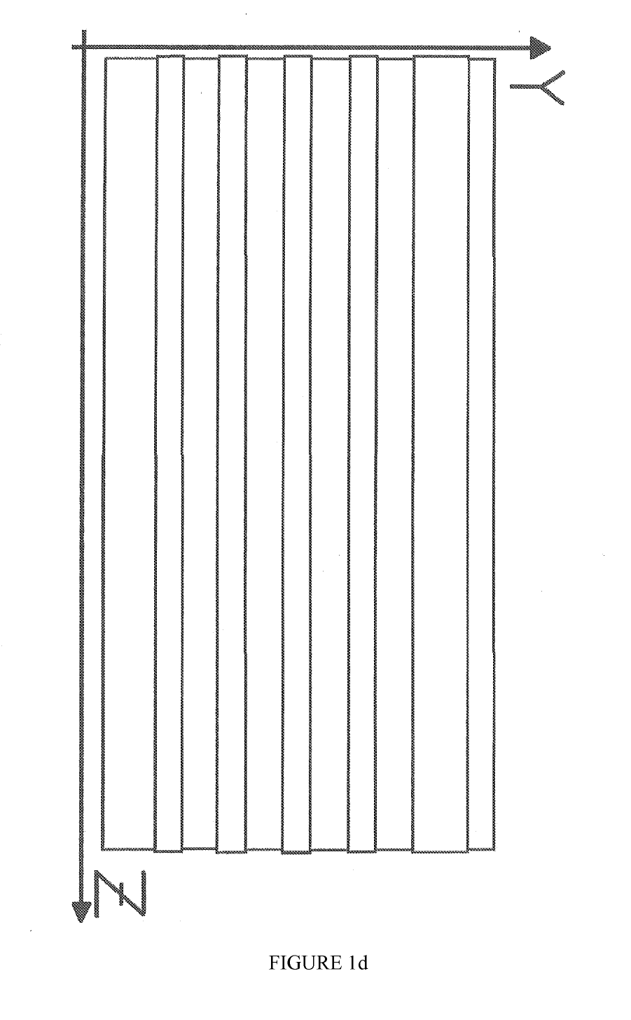

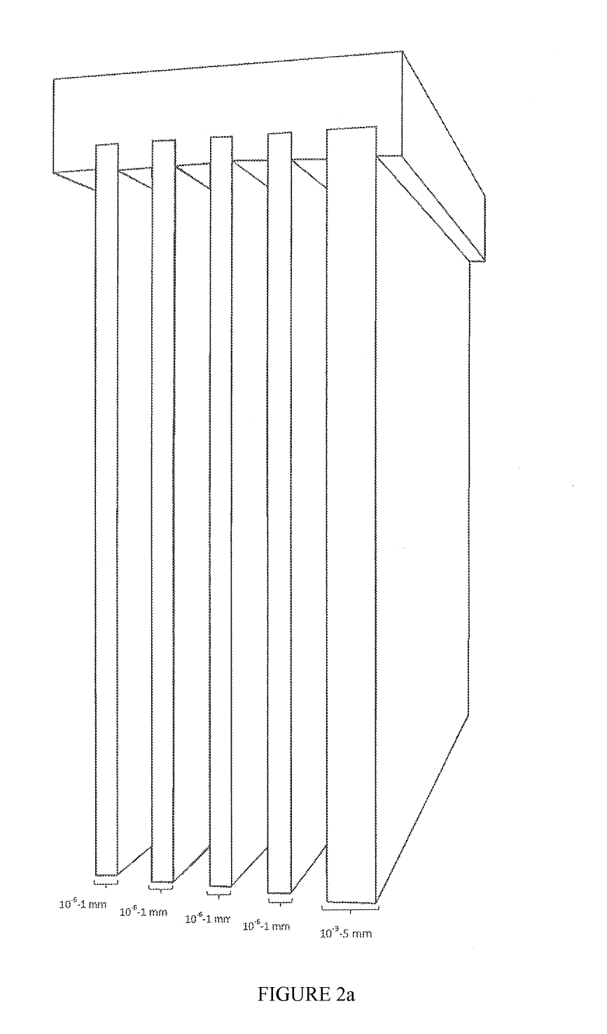

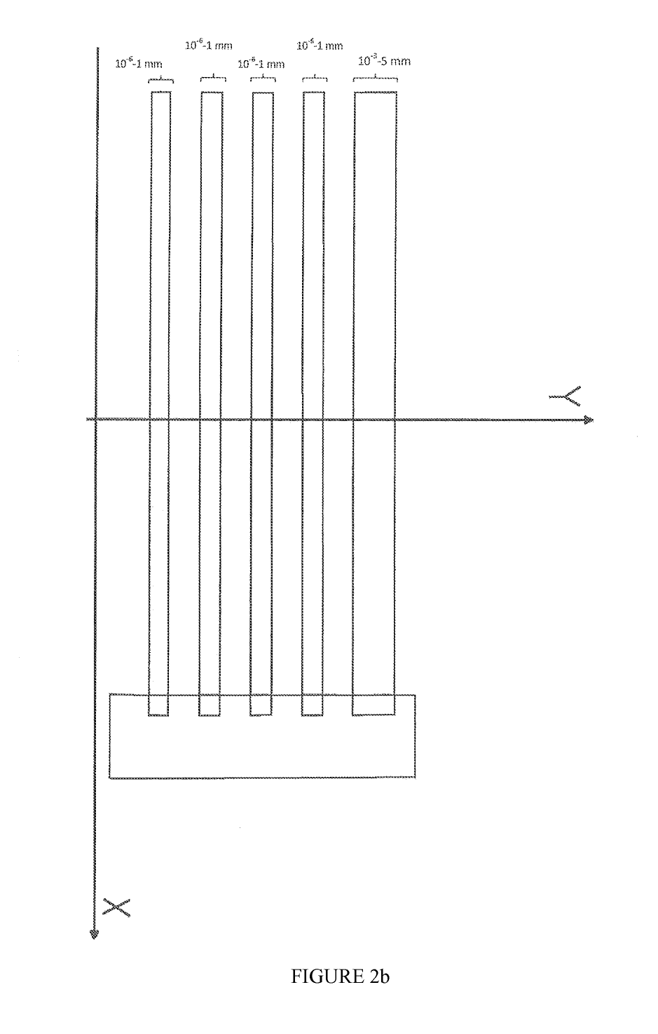

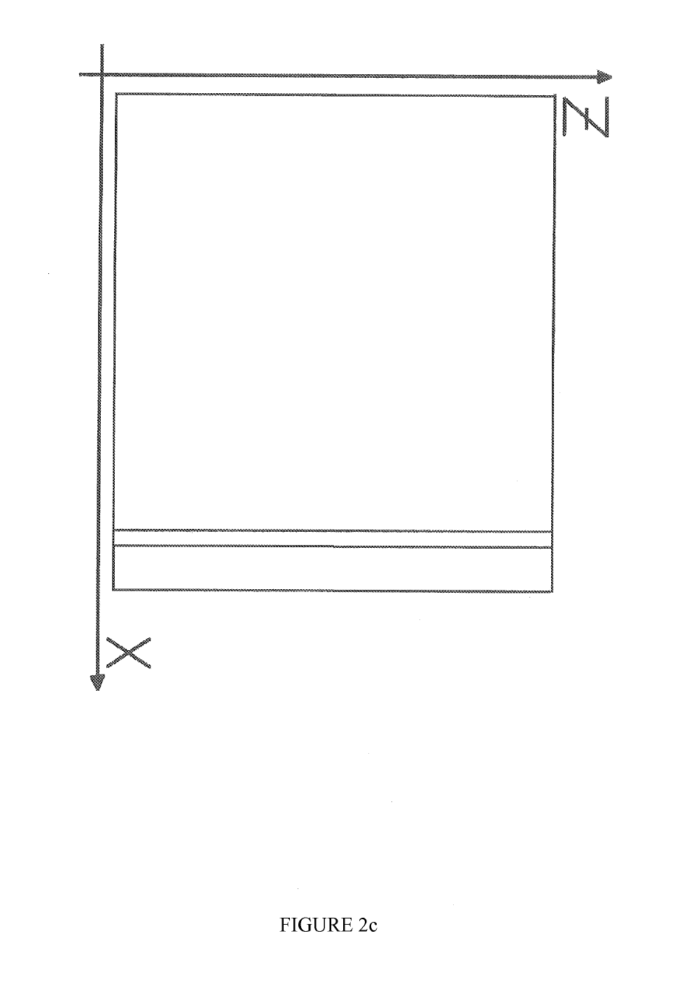

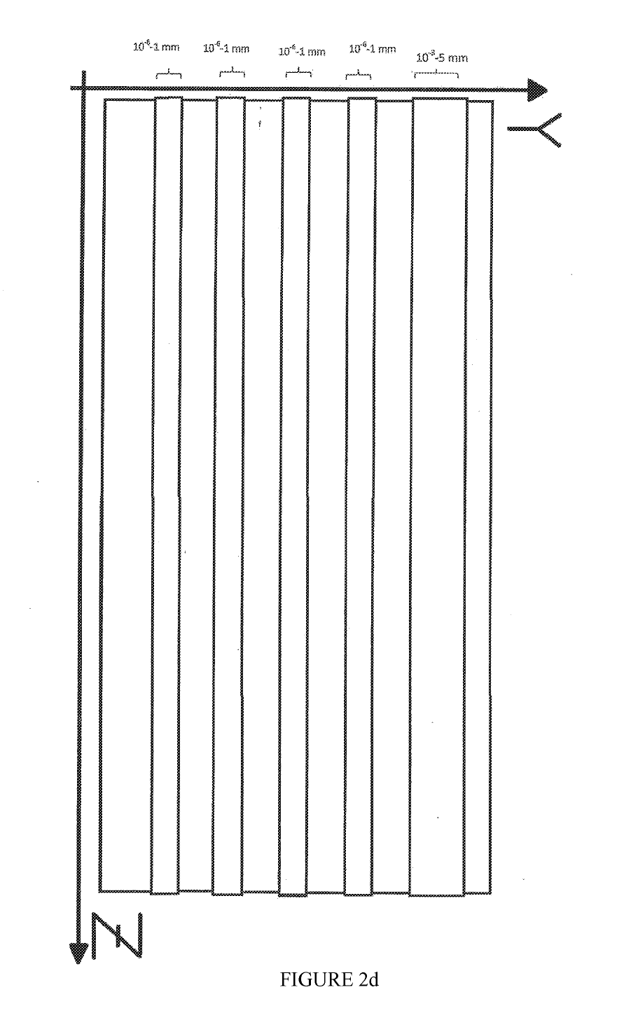

### DETAILED DESCRIPTION

Accordingly, it was the object of the present invention to provide a colour change material which allows a rapid change of the colour of its surface into essentially any colour while at the same time not needing to use high amounts of energy to effect a colour change.

Said object is solved by a multilayer colour change material, comprising a transparent or translucent top layer, a first colour layer comprising 2 flexible foils, a second colour layer comprising 2 flexible foils, a third colour layer comprising 2 flexible foils, a fourth colour layer comprising 2 flexible foils, a fifth colour layer comprising 2 flexible foils, whereby the first to third colour layer are each connected with a colour fluid reservoir device which allows to influx colour fluid from a colour fluid reservoir into a space between the 2 flexible foils and which allows to drain colour fluid from the space between the 2 flexible foils back into the colour fluid reservoir device, and whereby the forth colour layer is connected with a black fluid reservoir device which allows to influx a black fluid from the black fluid reservoir into a space between the 2 flexible foils and which allows to drain black fluid from the space between the 2 flexible foils back into the black fluid reservoir device, and whereby the fifth colour layer is connected with a transparent fluid reservoir device which allows to influx a transparent fluid from the transparent fluid reservoir device into a space between the 2 flexible foils and which allows to drain transparent fluid from the space between the 2 flexible foils back into the transparent fluid reservoir device, and a back layer.

Such a colour change material allows to change the colour of its surface in a reversible manner. In contrast to other colour change materials, like conventional LED screens, the colour change material according to the present invention is very energy efficient.

The colour change material according to the present invention works under the principle of subtractive colour formation. The colour of the surface can be regulated by regulating the amount of colour fluids, black fluid and transparent fluid, respectively, which is influxed from the respective reservoir into the space between the flexible foils of the individual layers. Accordingly, the principal underlying the present invention is that by regulating the amount of colour fluids, black fluid and transparent fluid respectively within the individual layers, the thickness of a respective colour fluid film, black fluid film and transparent fluid film, respectively, within the space of the respective colour layers is regulated. By regulating the thickness of these individual films, the colour appearance of the surface of the multilayer colour change material can be regulated.

The regulation of the colour appearance of the surface of the colour change material takes place by regulating the volume of the individual colour fluids, black fluid, and transparent fluid, respectively, within the colour change material.

In case that the total volume of each of the colour fluids and the black fluid, respectively, is within the cylinders of the respective reservoirs and there is no amount of the colour fluids and black fluid within the first to fourth colour layer, the surface of the colour change device appears white or metallic, respectively (depending on whether the backlayer is white or metallic).

In case that the maximum volume of each of the colour fluids and the black fluid are within the first to fourth colour layer, the appearance of the surface of the multilayer colour change material is black.

The hue of the colour of the surface of the colour change material can be regulated by regulating the volume of the three colour fluids within the first to third colour layer.

The lightness of the colour of the surface of the multilayer colour change material can be regulated by regulating the volume of the black fluid within the fourth colour layer.

The saturation of the colour of the surface of the multilayer colour change material can be regulated by a combined regulation of the volume of the three colour fluids within the first to third colour layer and of the black fluid within the fourth colour layer.

In a preferred embodiment, the top layer comprises a polymer sheet having a thickness of 10⁻³ to 5, in particular 10⁻² to 2, mm. Preferably, the top layer comprises a polymeric sheet having a modulus of elasticity of 3000 to 70000, in particular 8000 to 20000, N/mm². In a further preferred embodiment, the top layer comprises a polymer sheet made from polymethylmethacrylate.

The material forming the flexible foils of the first to fifth colour layers should have a high elasticity in order to allow the expansion of the space between the two flexible foils upon influx of a colour fluid, a black fluid or a transparent fluid, respectively.

In a preferred embodiment, the flexible foils of the first to fifth colour layer have a thickness of 10⁻⁶ to 1, in particular 10⁻⁴ to 0.1, mm. Particularly advantageous properties are achieved when the flexible foils of the first to fifth colour layers have a modulus of elasticity of 1 to 5, in particular 2 to 3, kN/mm². A preferred material of the flexible foils of the first to fifth colour layers is polyethylene.

In order to allow a subtractive colour formation for the surface colour of the multi-layer colour change material according to the present invention, it is preferred to use the CMY colour system, which consists of the colours cyan, magenta, and yellow.

Accordingly, in a preferred embodiment of the multilayer colour change material according to the present invention the colour fluid in the colour fluid reservoir device connected to the first colour layer has the colour cyan, and the colour fluid in the colour fluid reservoir device connected to the second colour layer has the colour magenta, and the colour fluid in the colour fluid reservoir device connected to the third colour layer has the colour yellow.

Preferably, the cyan colour fluid has the composition:

Distilled H₂O, 0.7 g/l prussian blue

Preferably, the magenta colour fluid has the composition:

Distilled H₂O, 7×10⁻⁵ g/l NaOH, 0.7 g/l phenol red

Preferably, the yellow colour fluid has the composition:

Distilled H₂O, 7×10⁻⁶ g/l HCl, 0.7 g/l phenol red

Preferably, the black colour fluid has the composition:

Distilled H₂O, 0.7 g/l charcoal

Preferably, the transparent fluid has the composition:

Distilled H₂O

In order to connect the colour fluid reservoir, black fluid reservoir and transparent fluid reservoir to the respective colour layers in a way which allows to influx the respective fluids under defined pressure, the respective reservoirs are preferably connected to the individual layers by a dimensionally stable hollow body. In a preferred embodiment, each of the colour fluid reservoir devices, the black fluid reservoir device, and the transparent fluid reservoir device is connected to the respective colour layer by flexible pressure tubing.

Preferably, each of the colour fluid reservoir devices, the black fluid reservoir device and the transparent fluid reservoir device allow to influx colour fluid, black fluid, or transparent fluid, respectively, into the respective space between the 2 flexible foils under a defined pressure and allow to drain colour fluid, black fluid, or transparent fluid, respectively, from the space between the 2 flexible foils back into the colour fluid reservoir devices, the black fluid reservoir device and the transparent fluid reservoir device, respectively.

In a particularly preferred embodiment, each of the colour fluid reservoir devices comprises a cylinder filled with the colour fluid and an adjustable plunger which allows to influx the colour fluid into the respective space between the 2 flexible foils and which allows to drain colour fluid from the space between the 2 flexible foils back into the colour fluid reservoir device, and whereby the black fluid reservoir comprises a cylinder filled with black fluid and an adjustable plunger which allows to influx the black fluid into the respective space between the 2 flexible foils and which allows to drain black fluid from the space between the 2 flexible foils back into the black fluid reservoir device, and the transparent fluid reservoir comprises a cylinder filled with transparent fluid and an adjustable plunger which allows to influx the transparent fluid into the respective space between the 2 flexible foils and which allows to drain transparent fluid from the space between the 2 flexible foils back into the transparent fluid reservoir device.

Accordingly, by moving the individual plungers of the individual colour reservoir devices, black reservoir device and transparent reservoir device from one lockable position to another lockable position, the influx of colour fluid, black fluid and transparent fluid, respectively, in the respective colour layer can be regulated under a defined pressure.

In a further preferred embodiment, each of the colour fluid reservoir devices comprises a cylinder filled with the colour fluid and an adjustable plunger which allows to influx the colour fluid into the respective space between the 2 flexible foils under a defined pressure and which allows to drain colour fluid from the space between the 2 flexible foils back into the colour fluid reservoir device, and whereby the black fluid reservoir comprises a cylinder filled with black fluid and an adjustable plunger which allows to influx the black fluid into the respective space between the 2 flexible foils under defined pressure and which allows to drain black fluid from the space between the 2 flexible foils back into the black fluid reservoir device, and whereby the transparent fluid reservoir is a pressurized reservoir.

In this embodiment, the transparent fluid is under substantially constant pressure so that the transparent fluid within the fifth colour layer automatically drives out the colour fluids, and the black fluids out of their colour layers into the reservoirs, when the plungers of the respective reservoir, or black reservoir is not engaged. Accordingly, in the “white/transparent” state of this embodiment, which corresponds to the colour of the back layer, i. e. white or metallic, there is only transparent fluid within the multilayer colour change material. In order to colourise the surface of the colour change material, one or several of the colour fluids and/or the black fluid are pressurized by moving the plunger into another lockable position. By influxing the respective colour fluid and/or black fluid into the respective colour layer under defined pressure, a corresponding amount of the transparent fluid is forced out of the fifth colour layer into the pressurized reservoir.

The functioning of this embodiment can be explained as follows. In case that all four plungers of the three colour fluid reservoir and the plunger of the black fluid reservoir, respectively, are unlocked, the total volume of the colour fluids and the black fluid, respectively, is within the cylinders of the respective reservoirs while the pressurized reservoir for the transparent fluid drives the transparent fluid in the fourth colour layer. In this case, the surface of the colour change device appears white or metallic, respectively.

In case that all four plungers of the three colour fluid devices and the one reservoir for the black fluid device are fully engaged, i.e. locked in the innermost position, the appearance of the surface of the multilayer colour change material is black.

The hue of the colour of the surface of the colour change material can be regulated by regulating the position of the plungers of the three colour fluid reservoir devices.

The lightness of the colour of the surface of the multilayer colour change material can be regulated by regulating the position of the plunger in the black fluid reservoir.

The saturation of the colour of the surface of the multilayer colour change material can be regulated by a combined regulation of all four plungers of three colour fluid reservoir devices and the black fluid reservoir device.

In a preferred embodiment, the transparent fluid reservoir is in form of a balloon.

In a further preferred embodiment, the black layer is white or metallic.

In another preferred embodiment, the back layer is transparent or translucent.

The multilayer colour change material according to the present invention can be in form of a rigid panel having a thickness of 10⁻³ to 10, in particular 10⁻² to 5, mm. Such a rigid panel is particularly useful for providing a colour change surface to a flat surface like the surface of a table or a house wall.

Preferably, the multilayer colour change material in form of a rigid panel is having a thickness of 10⁻³ to 10 mm.

In an alternative embodiment, the colour change material according to the present invention can be in form of a flexible sheet. Such a flexible sheet is in particular useful for providing a colour change surface to a corpus having a complex shape, like a vehicle. Preferably, the colour change material in form of a flexible sheet is having a thickness of 10⁻² to 10, in particular 10⁻¹ to 1, mm.

The present invention is also directed to the use of a multilayer colour change material as described above as a colour change surface for buildings, furniture, textiles or vehicles. A particularly preferred use is the use as a colour change surface for vehicles. Alternatively, the present invention is also directed to the use of a multi colour change material as described above as a tingeing sheet for a window, which allows the colouring of the light transmitting the window.

1. Multilayer colour change material, comprising
a transparent or translucent top layer,
a first colour layer comprising 2 flexible foils,
a second colour layer comprising 2 flexible foils,
a third colour layer comprising 2 flexible foils,
a fourth colour layer comprising 2 flexible foils,
a fifth colour layer comprising 2 flexible foils,
whereby the first to third colour layer are each connected with a colour fluid reservoir device which allows to influx colour fluid from a colour fluid reservoir into a space between the 2 flexible foils and which allows to drain colour fluid from the space between the 2 flexible foils back into the colour fluid reservoir device,
and whereby the fourth colour layer is connected with a black fluid reservoir device which allows to influx a black fluid from the black fluid reservoir into a space between the 2 flexible foils and which allows to drain black fluid from the space between the 2 flexible foils back into the black fluid reservoir device,
and whereby the fifth colour layer is connected with a transparent fluid reservoir device which allows to influx a transparent fluid from the transparent fluid reservoir device into a space between the 2 flexible foils and which allows to drain transparent fluid from the space between the 2 flexible foils back into the transparent fluid reservoir device,
and a back layer.

2. Multilayer colour change material according to claim 1, whereby the top layer comprises a polymer sheet having a thickness of 10⁻³ to 5 mm.

3. The multilayer colour change material according to claim 1, whereby the top layer comprises a polymer sheet having a modulus of elasticity of 3000 to 70000 N/mm².

4. The multilayer colour change material according to claim 1, whereby the top layer comprises a polymer sheet made of polymethylmethacrylate.

5. The multilayer colour change material according to claim 1, whereby the flexible foils of the first to fifth colour layers have a thickness of 10⁻⁶ to 1 mm.

6. The multilayer colour change material according to claim 1, whereby the flexible foils of the first to fifth colour layers have a modulus of elasticity of 1 to 5 kN/mm².

7. The multilayer colour change material according to claim 1, whereby the flexible foils of the first to fifth colour layers are made of polyethylene.

8. multilayer colour change material according to claim 1, whereby the colour fluid in the colour fluid reservoir device connected to the first colour layer has the colour cyan, and the colour fluid in the colour fluid reservoir device connected to the second colour layer has the colour magenta, and the colour fluid in the colour fluid reservoir device connected to the third colour layer has the colour yellow.

9. The multilayer colour change material according to claim 1, whereby each of the colour fluid reservoir devices, the black fluid reservoir device, and the transparent fluid reservoir device are each connected to the respective colour layer by flexible pressure tubing.

10. The multilayer colour change material according to claim 1, whereby each of the colour fluid reservoir devices, the black fluid reservoir device and the transparent fluid reservoir device allow the influx colour fluid, black fluid, or transparent fluid, respectively, into the respective space between the 2 flexible foils under a defined pressure and allow to drain colour fluid, black fluid, or transparent fluid, respectively, from the space between the 2 flexible foils back into the colour fluid reservoir devices, the black fluid reservoir device and the transparent fluid reservoir device, respectively.

11. The multilayer colour change material according to claim 1, whereby each of the colour fluid reservoir devices comprises a cylinder filled with the colour fluid and an adjustable plunger which allows to influx the colour fluid into the respective space between the 2 flexible foils and which allows to drain colour fluid from the space between the 2 flexible foils back into the colour fluid reservoir device, and whereby the black fluid reservoir comprises a cylinder filled with black fluid and an adjustable plunger which allows to influx the black fluid into the respective space between the 2 flexible foils and which allows to drain black fluid from the space between the 2 flexible foils back into the black fluid reservoir device, and the transparent fluid reservoir comprises a cylinder filled with transparent fluid and an adjustable plunger which allows to influx the transparent fluid into the respective space between the 2 flexible foils and which allows to drain transparent fluid from the space between the 2 flexible foils back into the transparent fluid reservoir device.

12. The multilayer colour change material according to claim 1, whereby each of the colour fluid reservoir devices comprises a cylinder filled with the colour fluid and an adjustable plunger which allows to influx the colour fluid into the respective space between the 2 flexible foils under a defined pressure and which allows to drain colour fluid from the space between the 2 flexible foils back into the colour fluid reservoir device, and whereby the black fluid reservoir comprises a cylinder filled with black fluid and an adjustable plunger which allows to influx the black fluid into the respective space between the 2 flexible foils under defined pressure and which allows to drain black fluid from the space between the 2 flexible foils back into the black fluid reservoir device, and whereby the transparent fluid reservoir is a pressurized reservoir.

13. The multilayer colour change material according to claim 1, whereby the transparent fluid reservoir is in form of a balloon.

14. The multilayer colour change material according to claim 1, whereby the back layer is white or metallic.

15. The multilayer colour change material according to claim 1, whereby the back layer is transparent or translucent.

16. The multilayer colour change material according to claim 1, whereby the multilayer colour change material is in form of a rigid panel having a thickness of 10⁻³ to 10 mm.

17. The multilayer colour change material according to claim 1, whereby the colour change material is in form of a flexible sheet having a thickness of 10⁻² to 10 mm.

18. An article comprising the colour change material of claim 1, wherein the article is a building, an article of furniture, a textile, or a vehicle.

19. The article of claim 18, wherein the material is situated as a colour change surface on the article.

20. A window comprising the multilayer colour change material of claim 1, wherein the material is situated to allow the colouring of the light transmitting the window.
